(19) United States
(12) Patent Application Publication
(10) Pub. No.: US 2024/0012584 A1
(43) Pub. Date: Jan. 11, 2024

(54) DYNAMIC NORMALIZATION AND DENORMALIZATION OF METADATA

(71) Applicant: NUTANIX, INC., San Jose, CA (US)

(72) Inventors: Amod Vilas JALTADE, San Jose, CA (US); John CHAU, San Jose, CA (US); Praveen Kumar PADIA, Mountain View, CA (US); Radenko PAVLOVIC, Belgrade (RS); Vinayak Hindurao KHOT, Mountain View, CA (US)

(21) Appl. No.: 18/173,696

(22) Filed: Feb. 23, 2023

Related U.S. Application Data
(60) Provisional application No. 63/359,964, filed on Jul. 11, 2022.

(51) Int. Cl. G06F 3/06

(52) U.S. Cl. CPC G06F 3/0667; G06F 3/061; G06F 3/0647; G06F 3/067

(57) ABSTRACT

Various embodiments set forth techniques for managing metadata for a vblock include dynamically normalizing and denormalizing vblock metadata associated with an extent. Vblock metadata associated with an extent is normalized when the extent is migrated to a different extent group by having the vblock metadata to a mapping between the extent identifier and an extent group identifier in a metadata map separate from the vblock metadata. Vblock metadata associated with an extent is denormalized whenever the number of vblock metadata associated with an extent drops below a threshold. Vblock metadata is denormalized by updating the vblock metadata to include a mapping to an extent group, based on a mapping of the extent to the extent group in a separate metadata map, and then removing the mapping in the separate metadata map.

### CROSS-REFERENCE TO RELATED APPLICATIONS

This application claims benefit of the United States Provisional patent application titled “DYNAMIC NORMALIZATION AND DENORMALIZATION OF METADATA,” filed Jul. 11, 2022, and having Ser. No. 63/359,964. The subject matter of this related application is hereby incorporated herein by reference.

### TECHNICAL FIELD

The contemplated embodiments relate generally to management of storage in a computing system and, more specifically, to dynamic normalization and denormalization of virtual block (vblock) metadata.

### BACKGROUND

To facilitate the management of a virtual disk or vdisk, a storage system typically divides the vdisk into units called vblocks. As the vdisk and the various vblocks get written to by applications, the storage system updates various metadata to keep track of which regions of vblocks in a vdisk contain data and which regions do not contain data. When the storage system receives a read or write request for the vdisk, the vblock or vblocks corresponding to the requested data are identified and then the metadata for those vblocks is accessed to properly respond to the request.

Data that is stored in vblocks can be referenced using an extent. Metadata for an extent can refer to an extent group with which the extent is associated, and metadata for the extent group can link to a physical disk location of the vblock that contains the data for the extent. The reference to the extent group can be direct or indirect. In the direct, denormalized case, the metadata for an extent includes an identifier of an associated extent group, which directly keys into a metadata map of extent group metadata. As snapshots of the vdisk are taken, the metadata for the extent, including the extent group identifier, can be duplicated many times. If the extent is to be migrated to another extent group, then the extent metadata in its many duplicates needs to be updated, which can take up significant computing resources.

On the other hand, in the indirect, normalized case, the extent metadata refers to a separate metadata map that maps the extent identifier to an extent group identifier, and that extent group identifier keys into the metadata map of extent group metadata. Updating such metadata in the case of extent migration is less resource-intensive, as just the mapping of extent identifier to extent group identifier needs to be updated. On the other hand, the separate metadata map takes up additional metadata storage space. Further, the separate metadata map means that additional metadata lookups are needed to reach the corresponding data on physical disk, making reads and writes less efficient.

Accordingly, there is need for improved techniques for vblock metadata management.

### SUMMARY

Various embodiments of the present disclosure set forth a method for normalizing virtual block (vblock) metadata. The method includes migrating an extent from a first extent group to a second extent group, where one or more vblocks are associated with the extent in a first metadata map; in response to migrating the extent, generating a first mapping of the extent to the second extent group in a second metadata map; identifying one or more vblocks associated with the extent in the first metadata map; and updating metadata associated with the identified one or more vblocks in the first metadata map to refer to the first mapping in the second metadata map.

Various embodiments of the present disclosure set forth a method for denormalizing virtual block (vblock) metadata. The method includes identifying a plurality of vblocks that are associated with an extent in a plurality of virtual disks (vdisks); in response to determining that a number of the identified plurality of vblocks associated with the extent satisfies a denormalization criterion, updating metadata associated with the identified plurality of vblocks in a first metadata map to include an identifier of a first extent group included in a first mapping of a second metadata map, the first mapping associating the extent with the first extent group; and removing the first mapping from the second metadata map.

Other embodiments include, without limitation, a system that implements one or more aspects of the disclosed techniques, and one or more computer readable media including instructions for performing one or more aspects of the disclosed techniques.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a vblock extent metadata schema according to various embodiments of the present disclosure.

FIGS. 2A-2B illustrates an example of dynamic normalization of metadata according to various embodiments of the present disclosure.

FIGS. 3A-3C illustrates an example of dynamic denormalization of metadata according to various embodiments of the present disclosure.

FIG. 4 is a flow diagram of method steps for dynamically normalizing metadata, according to various embodiments of the present disclosure.

FIGS. 5A-5B illustrates an example of dynamic normalization of metadata according to additional embodiments of the present disclosure.

FIGS. 6A-6C illustrates an example of dynamic denormalization of metadata according to additional embodiments of the present disclosure.

FIG. 7 is a flow diagram of method steps for dynamically normalizing metadata, according to additional embodiments of the present disclosure.

FIG. 8 is a flow diagram of method steps for dynamically denormalizing metadata, according to various embodiments of the present disclosure.

FIGS. 9A-9D are block diagrams illustrating virtualization system architectures configured to implement one or more aspects of the present embodiments.

FIG. 10 is a block diagram illustrating a computer system configured to implement one or more aspects of the present embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### Vblock Extent Metadata Schema

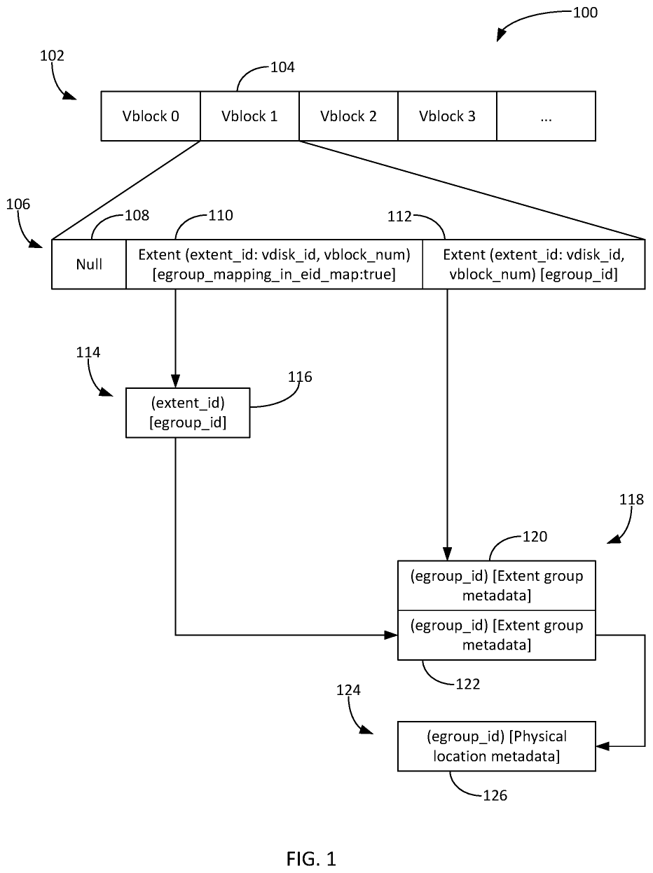

FIG. 1 is a block diagram illustrating a vblock extent metadata schema 100 according to various embodiments of the present disclosure. As shown in FIG. 1, schema 100 provides the metadata for extents stored on a vdisk 102, which is divided into a number of vblocks. A given vblock 104 can include one or more regions, each of which can include null data (which can also be referred to as zero data) or data associated with an extent. A vdisk block map 106 includes metadata indicating vblock regions within respective vblocks and their contents (e.g., null data or data associated with an extent).

Vdisk block map 106 includes, for a given vblock, metadata for any number of regions of extent data or null data included within the given vblock. For example, as shown in FIG. 1, for vblock 104, vdisk block map 106 includes region metadata entries 108, 110 and 112. A region, which is a contiguous set of offsets within the vblock, is specified by a starting offset and a length (not shown in FIG. 1). Region metadata entry 108 indicates that a first region has null data; region metadata entry 108 includes a starting offset and length (not shown) defining that first region. Region metadata entries 110 and 112 describe a second and third region, respectively, where each has non-null data associated with an extent. Data associated with an extent corresponds to data stored in a physical storage medium (e.g., a physical disk), which can be located via metadata. Each of region metadata entries 110 and 112 also includes a starting offset and length (not shown) defining that respective region.

As shown, each of region metadata entries 110 and 112 each includes an extent_id, which is an identifier of the associated extent. In some embodiments, the extent_id includes a vdisk_id (identifier of a vdisk from which the data originated) and a vblock_num (identifier of the vblock in the vdisk from which the data originated). In some embodiments, the extent_id serves as a key into vdisk block map 106; a given extent indicated in vdisk block map 106 is identified by the extent_id.

Region metadata for an extent includes an egroup_id (identifier of an extent group with which the extent is associated) and/or an egroup_mapping_in_eid_map flag (a flag indicating whether the egroup_id for that extent is located in a separate metadata map). For example, region metadata entry 110 includes an egroup_mapping_in_eid_map flag marked as true (e.g., set to 1). The egroup_id for the extent indicated by region metadata entry 110 is obtained indirectly from an extent id map 114, further described below. In some embodiments, region metadata entry 110 additionally includes an egroup_id. The egroup_id can serve as a “hint” for lookups to extent group id map 118 that bypass extent id map 114, similar to lookups using region metadata entry 112 described below.

As an alternate example of a region metadata entry, region metadata entry 112 includes an egroup_id. The egroup_id for the extent indicated by region metadata 112 is obtained directly from region metadata entry 112 without resorting to looking up extent id map 114. In some embodiments, region metadata entry 112 includes an egroup_mapping_in_eid_map flag marked as false (e.g., reset to 0).

The egroup_id is a key into an extent group id map 118, which includes entries (e.g., entries 120 and 122) containing extent group metadata for extent groups. Extent group metadata includes metadata indicating a state of the extent group and/or a physical location of data corresponding to the extent group. In some embodiments, extent group metadata includes control information (e.g., version number of metadata, list of extents, list of slices (units of physical disk allocation) in the extent group, etc.) and/or a list of replicas or disks on which data corresponding to the extent group resides.

When an application wants to access data stored on a vdisk, the application provide a vdisk identifier and a range of addresses on vdisk that are to be accessed. The range of addresses are then mapped to one or more vblock identifiers. Each of the vblock identifiers is used to access vdisk block map 106 to determine whether each vblock has a region metadata entry (e.g., region metadata entry 108, 110, or 112). When the region metadata entry is null (e.g., similar to region metadata entry 108), the region metadata entry is updated if the access is a write access or the region is not access if the access is a read access. When the region metadata entry region metadata entry includes an egroup_mapping_in_eid_map flag marked as true (e.g., similar to region metadata entry 110), the extent_id is used to lookup and read the egroup_id for the region is read from the region metadata entry and used to look up the egroup_id for the region in the extent id map 114. The egroup_id is then used to look up and read the extent group metadata for the region from the extent group id map 118. When the region metadata entry does not include an egroup_mapping_in_eid_map flag marked as true (e.g., similar to region metadata entry 112), the egroup_id is read from the region metadata entry and the region metadata entry is then used to look up and read the extent group metadata for the region from the extent group id map 118.

In some embodiments, schema 100 further includes an extent group id physical state map 124, into which an egroup_id is also a key. An entry 126 in extent group id physical state map 124 includes physical location metadata, which includes control information about the last write for the associated extent group, a global metadata version, information about extents and slices within the extent group, etc.

As described above, an egroup_id for a region is obtained indirectly from extent id map 114, or directly from a region metadata entry in vdisk block map 106. For example, the egroup_id for the extent indicated by region metadata entry 112 is obtained directly from region metadata entry 112. Accordingly, region metadata entry 112 maps directly to an entry 120 in extent group id map 118; the extent_id maps to an egroup_id directly within region metadata entry 112. Region metadata entry 112 is an example of denormalized metadata. As snapshots of vdisk 102, and accordingly snapshots of the associated metadata, are made, a denormalized region metadata entry is duplicated multiple times. A drawback of denormalized metadata is a high resource expense that is incurred to update the multiple duplicates of the region metadata entry, in particular updating the mapping of the extent_id to the egroup_id, when an extent identified by the extent_id is migrated to another extent group.

Alternatively, region metadata entry 110 includes an egroup_mapping_in_eid_map flag marked as true. Based on the egroup_mapping_in_eid_map flag marked as true, the egroup_id for the extent indicated by region metadata entry 110 is obtained from an entry 116 in extent id map 114. An extent_id of the extent is a key to entry 116 in extent id map 114; the extent_id maps to an egroup_id via extent id map 114. In some embodiments, in multiple snapshots of vdisk 102, multiple snapshots of region metadata entry 110 included in the vdisk snapshots refer to the same entry 116 in in extent id map 114. Region metadata entry 110 is an example of normalized metadata. Normalized metadata avoids the above-described drawback of denormalized metadata—when an extent group is migrated, just the extent id map 114 would need to be updated instead of updating each duplicate region metadata entry.

However, normalized metadata also has certain drawbacks. One drawback is that extent id map 114 incurs additional resource costs (e.g., in additional in-memory data structures) that would otherwise not be incurred when the metadata is denormalized. Additionally, extent id map 114 is an additional stage in a lookup to reach data on a physical disk. A lookup for data on physical disk, associated with an extent, would additionally include looking up extent id map 114 when the metadata is normalized, versus going from vdisk block map 106 directly to extend group id map 118 in the denormalized metadata scenario. While region metadata entry 110 with a true egroup_mapping_in_eid_map flag still includes an egroup_id, which would provide a bypass of vdisk block map 106 in a lookup, that egroup_id information becomes stale and incorrect as region metadata entry 110 is duplicated multiple times via snapshots and the corresponding extent is migrated throughout its life.

### Dynamic Normalization and Denormalization of Metadata

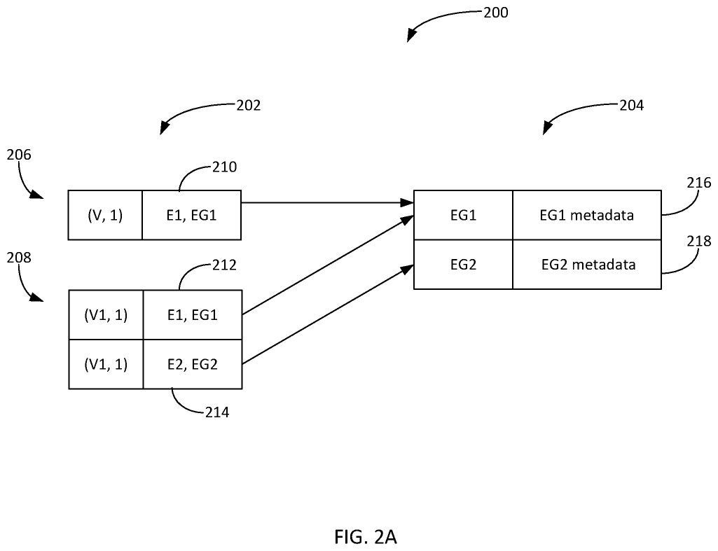

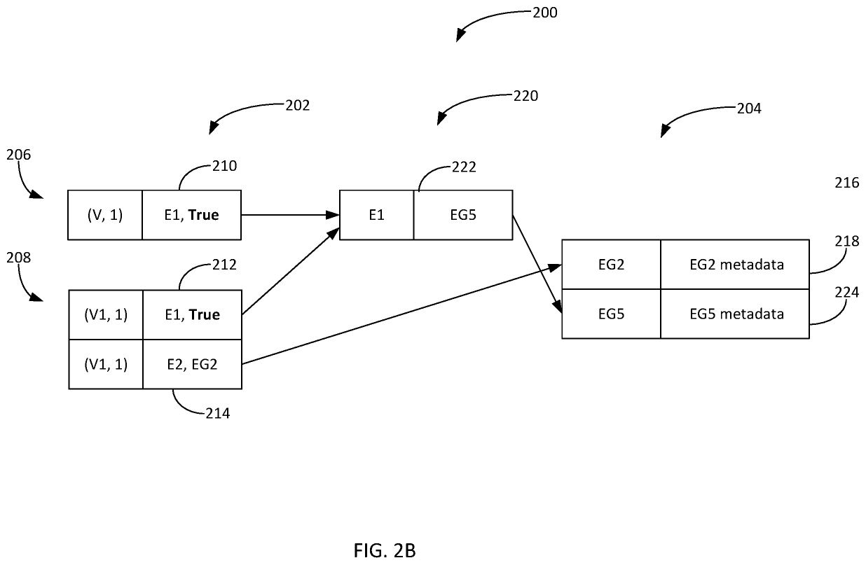

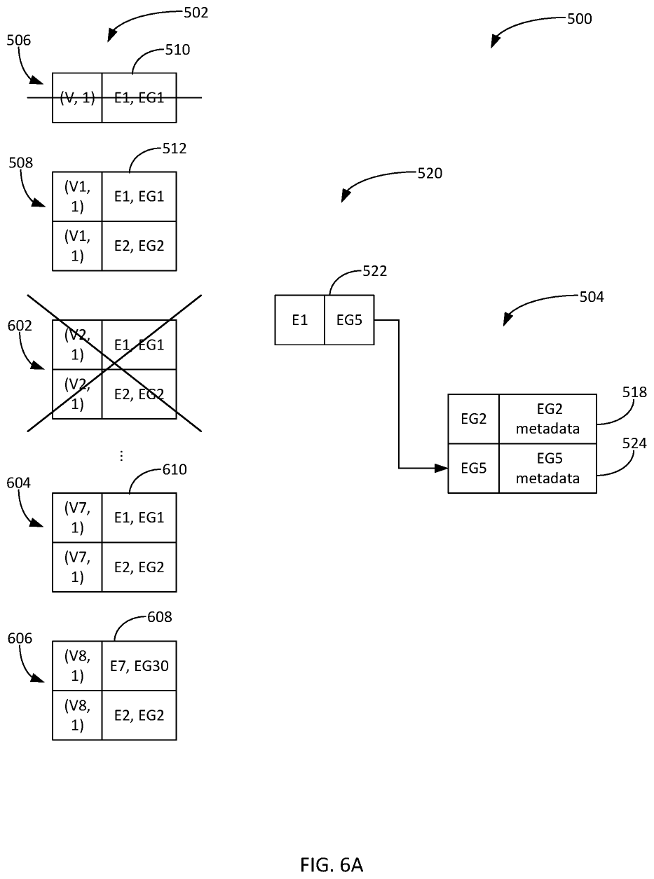

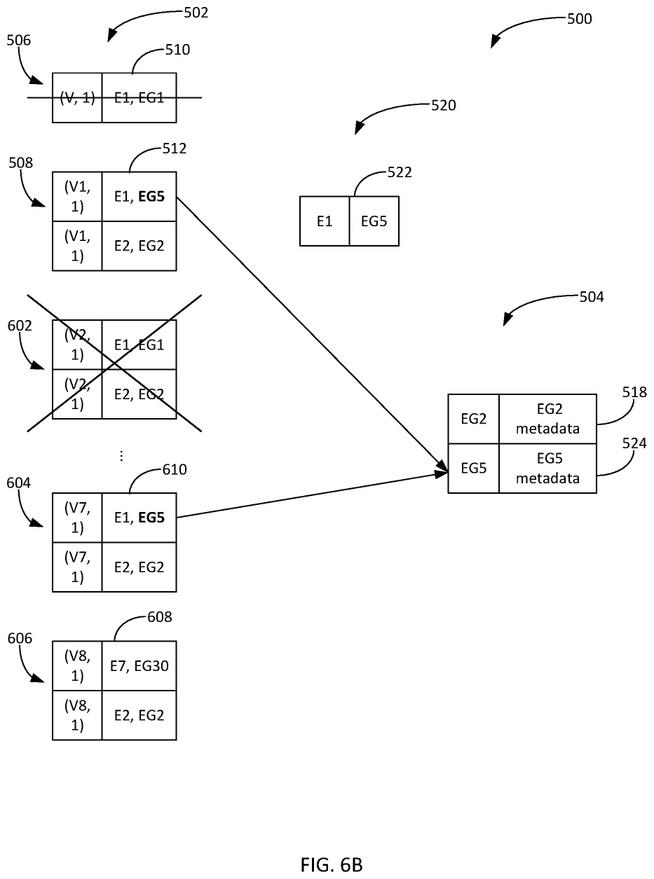

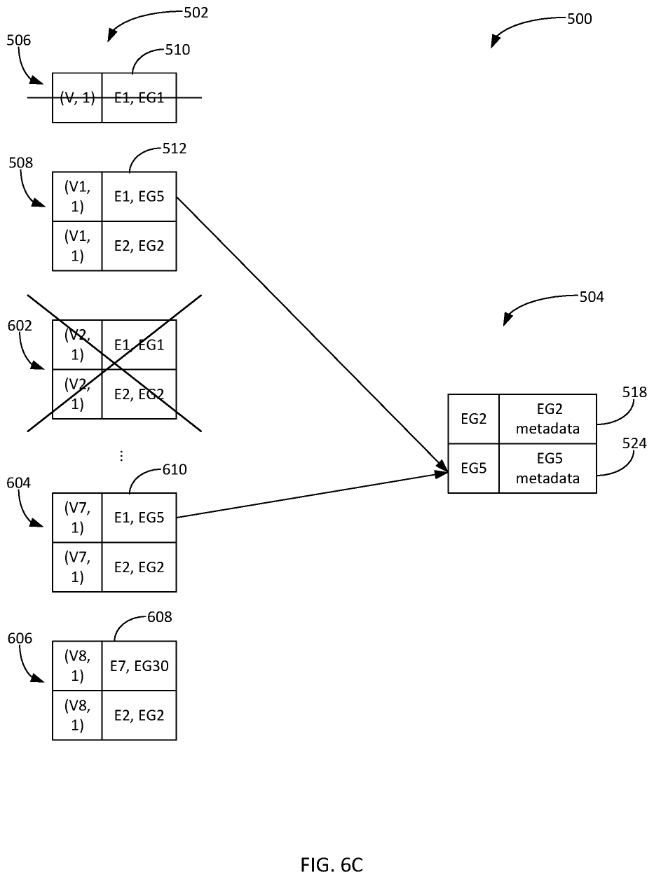

To address the respective drawbacks of denormalized and normalized metadata, while obtaining their respective benefits and advantages, metadata is dynamically normalized and denormalized. In some embodiments, dynamic normalization includes normalizing metadata in one or more entries in vdisk block map 106 by generating an entry in extent id map 114 and having those one or more entries in vdisk block map 106 refer to the entry in extent id map 114. In some embodiments, those one or more entries in vdisk block map 106 are normalized when a location of the corresponding extent is changed (e.g., when the extent is migrated). In some embodiments, dynamical normalization and denormalization of metadata is performed by a metadata manager application, which can be a part of a virtual disk manager application. FIGS. 2A-2B and 6A-6B illustrate examples of dynamic normalization of metadata.

FIG. 2A illustrates an example of denormalized metadata according to various embodiments of the present disclosure. Metadata 200 includes vdisk block maps 202 for multiple vdisks (e.g., multiple snapshots of a vdisk) and an extent group id map 204. Vdisk block maps 202 include metadata 206 for a vblock identified as “V, 1” (vdisk V, block 1), and metadata 208 for a vblock identified as “V1, 1” (vdisk V1, block 1). The vblocks identified by metadata 206 and 208 are the same block 1 in different versions or snapshots of a vdisk V (V and V1). Metadata 206 for vblock “V, 1” includes metadata entry 210 that maps extent E1 to extent group EG1 (e.g., extent_id E1 to egroup_id EG1). That is, vblock “V, 1” includes data associated with extent E1. Metadata 208 for vblock “V1, 1” includes metadata entry 212 that maps extent E1 to extent group EG1, and metadata entry 214 that maps extent E2 to extent group EG2 (e.g., extent_id E2 to egroup_id EG2). That is, vblock “V1, 1” includes the data associated with extent E1, inherited from vblock “V, 1,” and data associated with extent E2, which is new to vblock “V1, 1.” Egroup_id EG1 in metadata entries 210 and 212 maps to EG1 metadata entry 216 in extent group id map 204, and egroup_id EG2 in metadata entry 214 maps to EG2 metadata entry 218 in extent group id map 204. As long as the locations of extents E1 and E2 are not changed (e.g., extent E1 remains in extent group EG1, extent E2 remains in extent group EG2), when vblocks “V, 1” or “V1, 1” are duplicated via snapshots, metadata entries 210, 212, and 214 remains denormalized.

Continuing from FIG. 2A, an extent is migrated from one extent group to another. For example, extent E1 is migrated from extent group EG1 to extent group EG5. Instead of updating each of metadata entries 210 and 212 to reflect the migration, a metadata entry in an extent id map 220 is generated to normalize metadata entries 210 and 212. As shown in FIG. 2B, a metadata entry 222 in extent id map 220 is generated. If extent id map 220 does not already exist, one is generated, and a metadata entry 222 for extent E1 is generated along with extent id map 220. If an extent id map 220 already exists, metadata entry 222 for extent E1 is generated and added to extent id map 220. As shown, metadata entry 222 maps extent_id E1 to egroup_id EG5. In addition, metadata entry 216 in extent group id map 204 is removed. In some embodiments, the egroup_mapping_in_eid_map flags in metadata entries 210 or 212 are set to true, as shown in bold text in FIG. 2B, to indicate that the extent_id to egroup_id mapping is now located in extent id map 220. Accordingly, when either metadata entries 210 or 212 are processed to look up the extent group for extent E1, both metadata entries 210 and 212 would refer to metadata entry 222. Metadata entry 222 refers to EG5 metadata entry 224 in extent group id map 204 in view of the migration of extent E1. Meanwhile, metadata entry 214 continues to refer directly to EG2 metadata entry 218 in extent group id map 204; extent E2 has not been migrated and thus metadata entry 214 remains denormalized. If extent E1 is subsequently migrated to another extent group, then in lieu of updating metadata entries 210 and 212, metadata entry 222 is updated to map extent E1 to that another extent group to which extent E1 is migrated. Alternatively, a new metadata entry mapping extent E1 to the another extent group is added into extent group id map 204 to reflect the subsequent migration. In some embodiments, after the normalization, lookups to access EG5 metadata entry 224 would proceed from metadata entry 210 or 212 to metadata entry 222 in extent id map 220, based on the true egroup_mapping_in_eid_map flag, using the extent_id for extent E1 as the key.

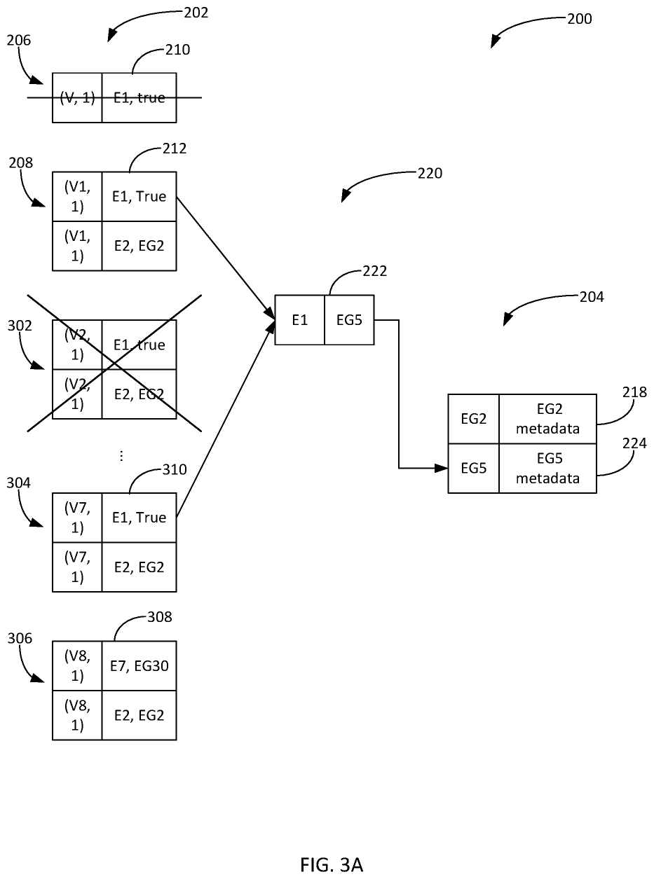

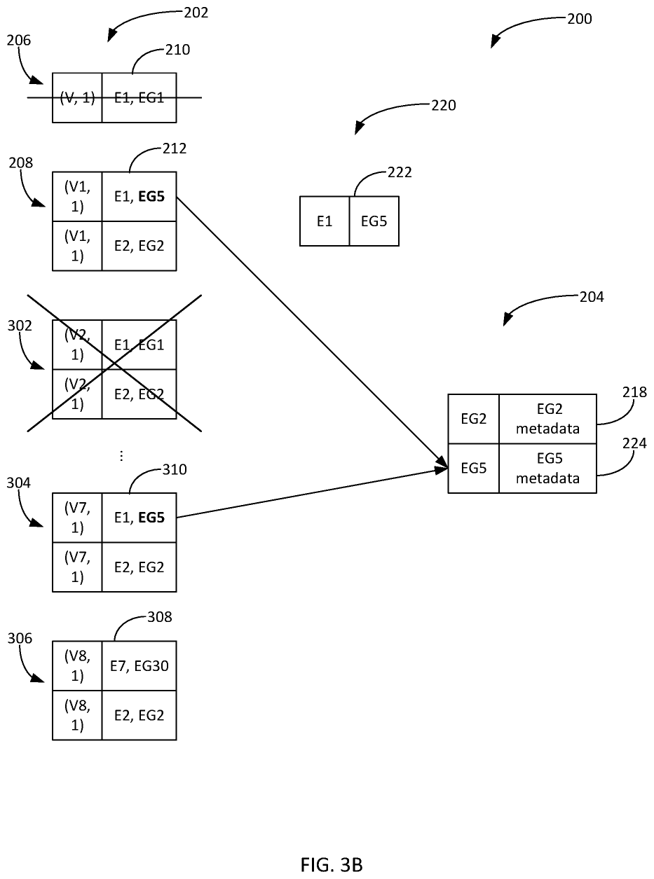

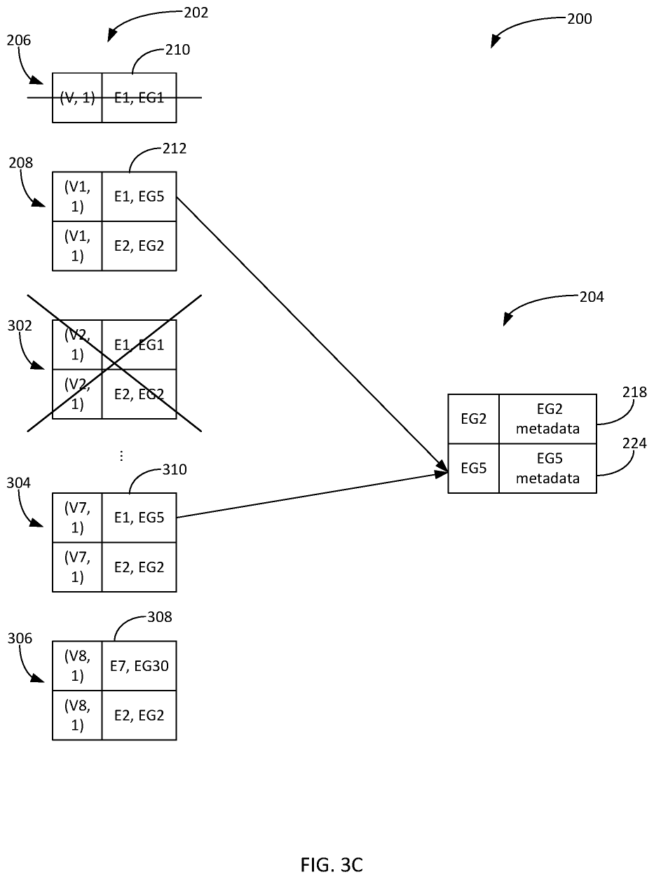

FIGS. 3A-3C illustrate an example of dynamic denormalization of metadata according to various embodiments of the present disclosure. Over time, multiple snapshots of a vdisk are taken. These snapshots reflect changes to a vblock in the vdisk over time. For example, a vblock is overwritten one or more times, such that a number of vdisk snapshots that include data associated with an extent decreases. Further, certain snapshots are deleted entirely. FIG. 3A illustrates an example of metadata 200 from FIGS. 2A-2B further ahead in time. As shown, subsequent to the example illustrated in FIGS. 2A-2B, additional metadata 302, 304, and 306 for respective snapshots of the vdisk (V2, V7, and V8, respectively) had been generated. Further, metadata 206 and 302 for vdisk snapshots V and V2, respectively, had been deleted, as shown by metadata 206 and 302 being crossed out. Further, in metadata 306 for vdisk snapshot V8, vblock 1 had been overwritten such that vblock 1 in vdisk v8 no longer includes data associated with extent E1, as shown in metadata entry 308 by the reference to extent E7. As further shown, metadata 208 and 304 still refer to extent E1 in metadata entries 212 and 310 and include egroup_mapping_in_eid_map flags set to true, respectively, and correspondingly refer to metadata entry 222 for extent E1, in extent id map 220. Metadata entry 222 continues to refer to EG5 metadata entry 224 in extent group id map 204.

When the number of vdisk snapshots that include data associated with an extent, and thereby has corresponding normalized metadata that includes a reference to the extent, is determined to meet a denormalization criterion, the metadata is dynamically denormalized. In some embodiments, a denormalization criterion is that the number of snapshots that include data associated with the extent meets or is below a threshold (e.g., 2 snapshots or versions of the vdisk as shown, however other numbers of snapshots can be used such as 3, 4, or more). In some embodiments, a denormalization criterion is a ratio or percentage of the number of snapshots that include data associated with the extent and a number of total snapshots meets or is below a threshold (e.g., 5% or 10%). More generally, the threshold is predefined or otherwise configured (e.g., by an administrator). Dynamic denormalization includes first updating the extent group references for that extent in the metadata. FIG. 3B illustrates the updating of extent group references. As descried above, metadata 208 and 304 still refer to extent E1 in metadata entries 212 and 310, respectively. In FIG. 3A, the associated metadata entries 212 and 310 include egroup_mapping_in_eid_map flags set to true. Using the mapping of extent_id to egroup_id included in metadata entry 222, each of metadata entries 212 and 310 is updated to include a reference to extent group EG5 (e.g., to include egroup_id EG5), as shown in bold text in FIG. 3B. As shown in FIG. 3B, each of metadata entries 212 and 310 now refers to extent group EG5 metadata entry 224 in extent group id map 204. That is, metadata entries 212 and 310 are updated to include the mapping of extent_id E1 to egroup_id EG5. In some embodiments, the true setting for the egroup_mapping_in_eid_map flags in metadata entries 210 and 310 is cleared.

Dynamic denormalization continues with deletion of an entry in extent id map 220. Continuing from FIG. 3B, after each of metadata entries 212 and 310 has been updated to include a reference to extent group EG5, metadata entry 222 in extent id map 220 is redundant and no longer needed. Accordingly, metadata entry 222 is deleted. In some embodiments, if metadata entry 222 is the last entry remaining in extent id map 220, then extent id map 220 is deleted in its entirety as well. As shown in FIG. 3C, with the updates to metadata entries 210 and 310 and deletion of metadata entry 222, metadata entries 210 and 310 refer directly to EG5 metadata entry 224 in extent group id map 204.

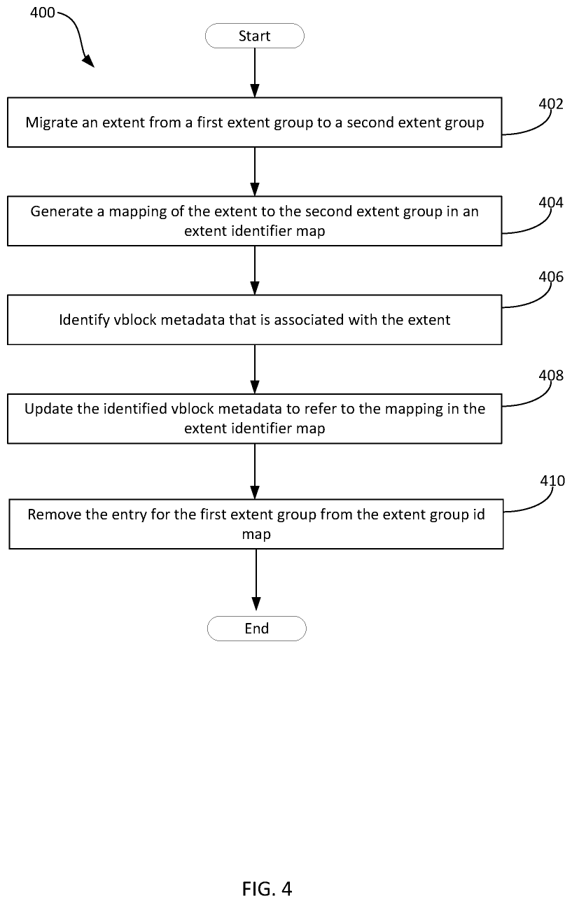

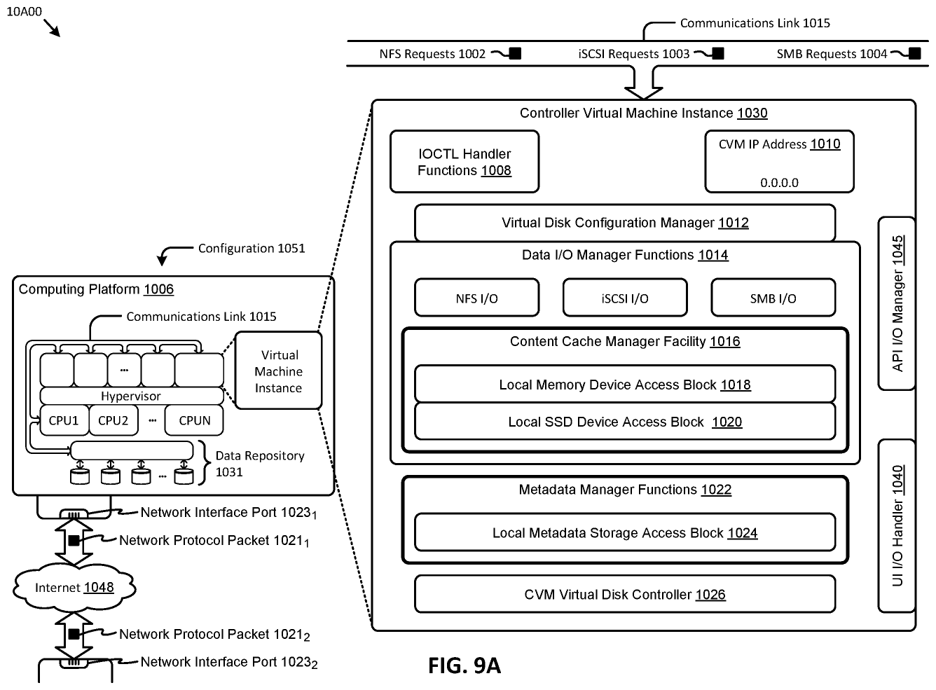

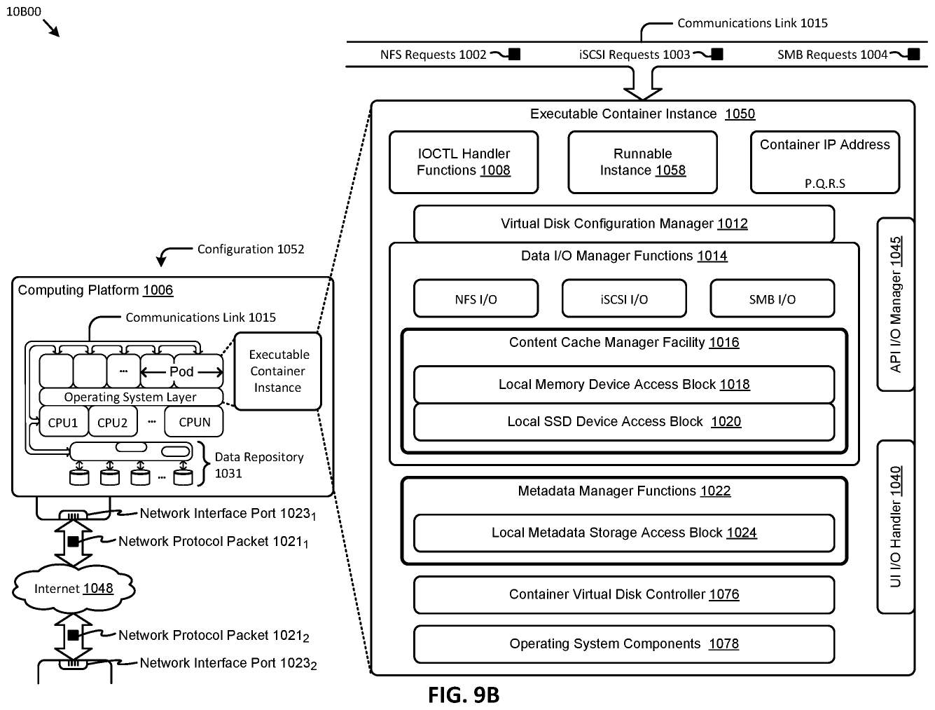

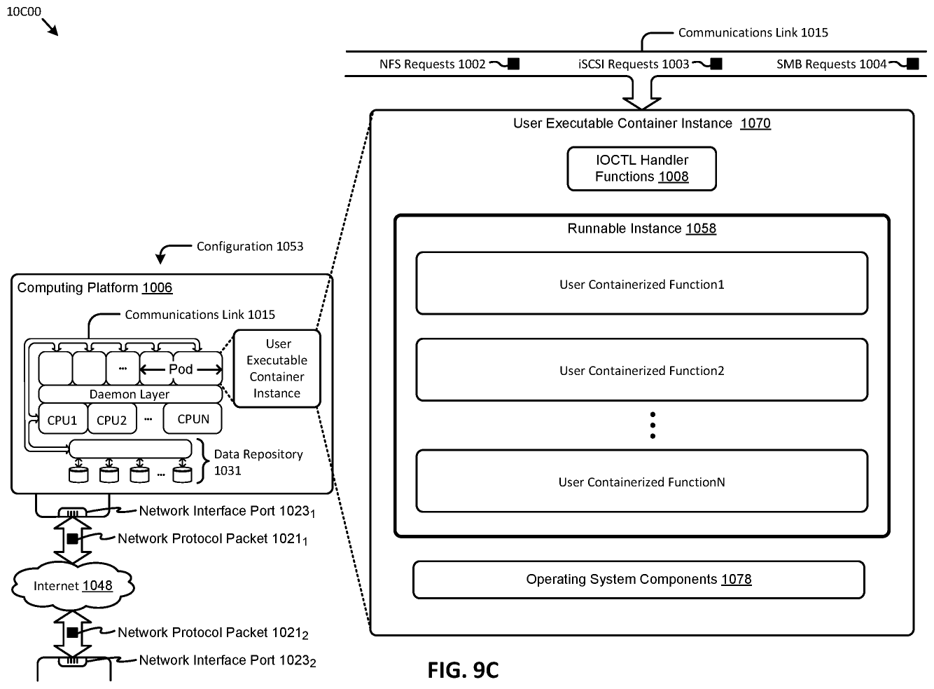

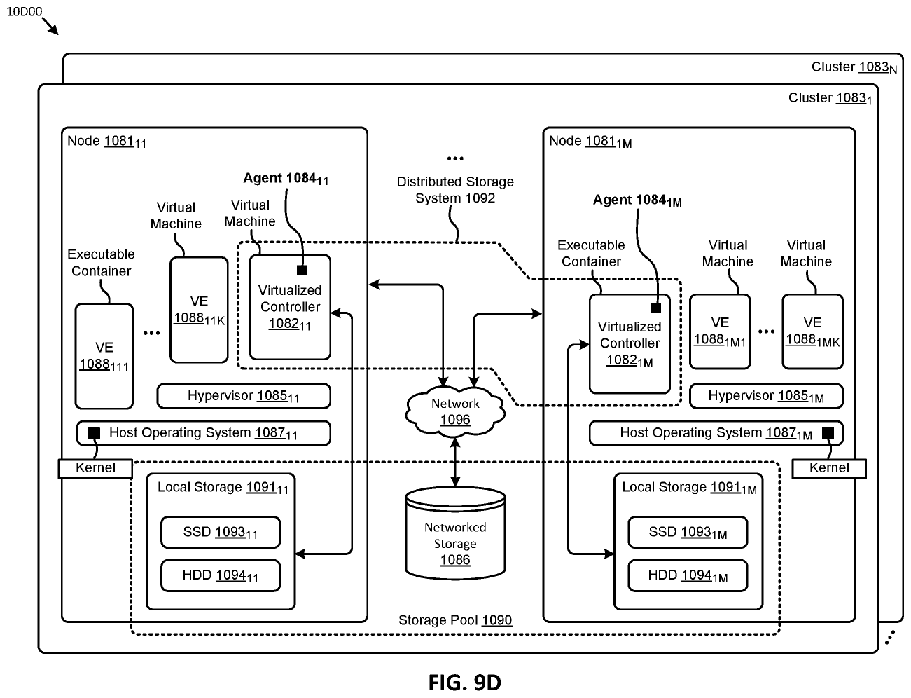

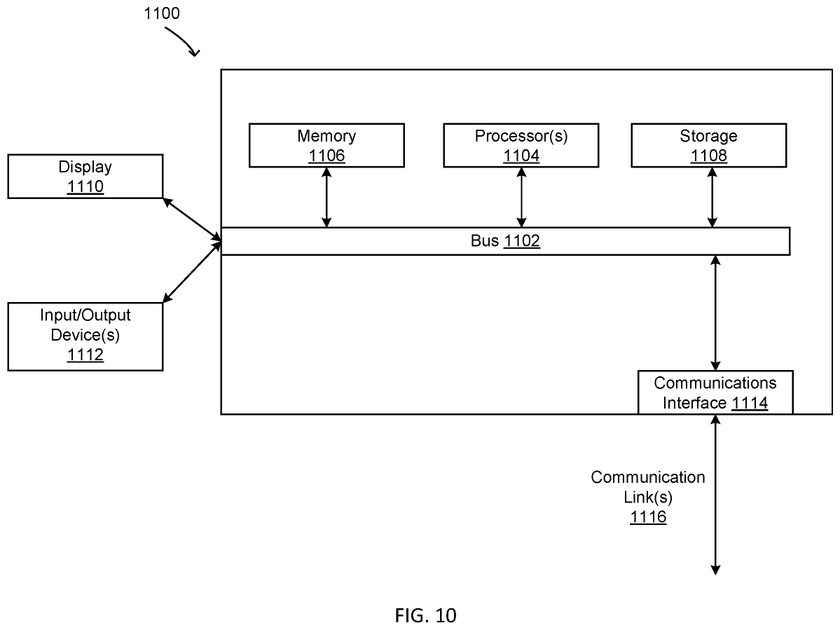

FIG. 4 is a flow diagram of method steps for dynamically normalizing metadata, according to various embodiments of the present disclosure. In some embodiments, the method steps of FIG. 4 may be performed by any computing device or system implementing a virtual disk, such as any of the computing systems disclosed in FIGS. 9A-10 disclosed herein.

As shown in FIG. 4, a method 400 begins at a step 402 where a virtual disk manager application migrates an extent from a first extent group to a second extent group. Migrating the extent includes associating the extent, which had been associated with the first extent group, with a second extent group. For example, referring to FIGS. 2A-2B, the virtual disk manager application migrates extent E1 from extent group EG1 to extent group EG5.

At step 404, in response to migrating the extent, the virtual disk manager application generates a mapping of the extent to the second extent group in an extent identifier map. The virtual disk manager application, in response to the migration of extent E1, generates metadata entry 222 in extent id map 220 that maps extent E1 to extent group EG5 as shown in FIG. 2B.

At step 406, the virtual disk manager application identifies vblock metadata that is associated with the extent. The virtual disk manager application searches through vdisk metadata throughout multiple snapshots to identify vblock metadata that are associated with the extent. For example, the virtual disk manager application identifies metadata entries 210 and 212 that are associated with extent E1.

At step 408, the virtual disk manager application updates the identified vblock metadata to refer to the mapping in the extent identifier map. The virtual disk manager application updates the vblock metadata to refer to metadata entry 222, generated in step 404, for lookups of data corresponding to extent E1. For example, the egroup_mapping_in_eid_map flags in metadata entries 210 and 212 are set to true as shown in FIG. 2B.

At step 410, the virtual disk manager application removes the entry for the first extent group from the extent group id map. For examples, the metadata entry 516 for extent group EG1 is removed from extent group id map 204 as shown in FIG. 2B.

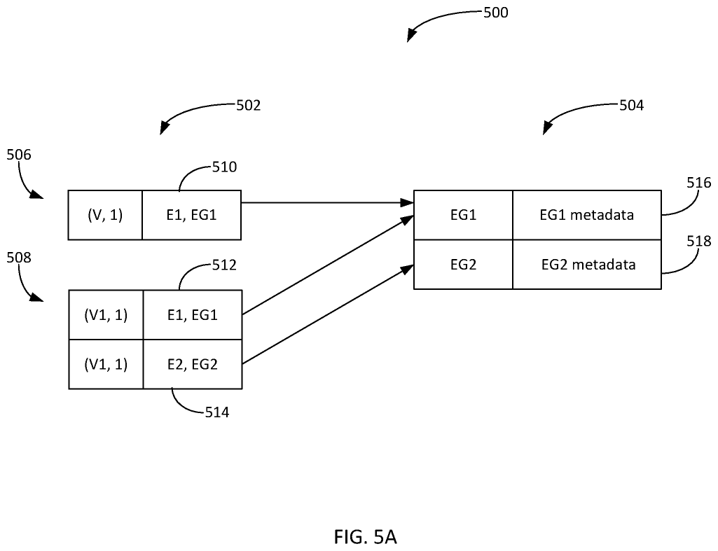

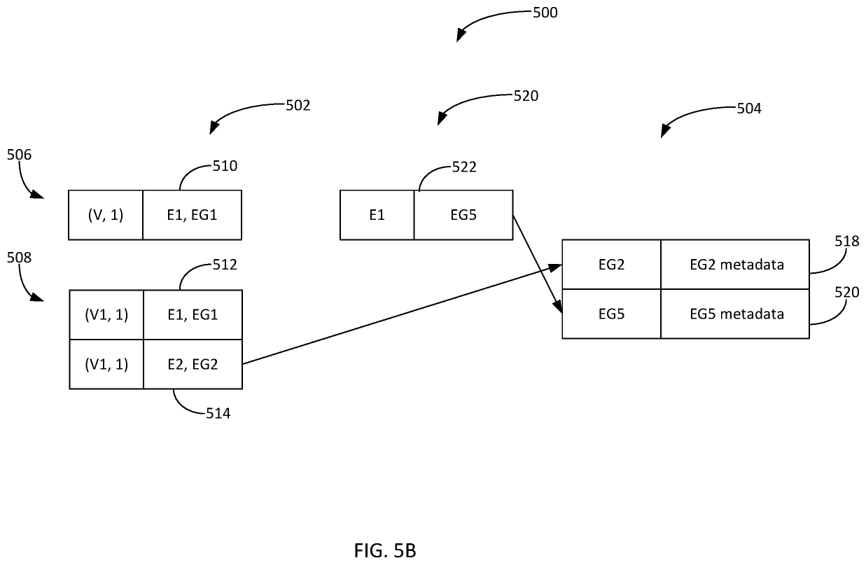

FIG. 5A illustrates an example of denormalized metadata according to additional embodiments of the present disclosure. Metadata 500 includes vdisk block maps 502 for multiple vdisks (e.g., multiple snapshots of a vdisk) and an extent group id map 504. Vdisk block maps 502 include metadata 506 for a vblock identified as “V, 1” (vdisk V, block 1), and metadata 508 for a vblock identified as “V1, 1” (vdisk V1, block 1). The vblocks identified by metadata 506 and 508 are the same block 1 in different versions or snapshots of a vdisk V (V and V1). Metadata 506 for vblock “V, 1” includes metadata entry 510 that maps extent E1 to extent group EG1 (e.g., extent_id E1 to egroup_id EG1). That is, vblock “V, 1” includes data associated with extent E1. Metadata 508 for vblock “V1, 1” includes metadata entry 512 that maps extent E1 to extent group EG1, and metadata entry 514 that maps extent E2 to extent group EG2 (e.g., extent_id E2 to egroup_id EG2). That is, vblock “V1, 1” includes the data associated with extent E1, inherited from vblock “V, 1,” and data associated with extent E2, which is new to vblock “V1, 1.” Egroup_id EG1 in metadata entries 510 and 512 maps to EG1 metadata entry 516 in extent group id map 504, and egroup_id EG2 in metadata entry 514 maps to EG2 metadata entry 518 in extent group id map 504. As long as the locations of extents E1 and E2 are not changed (e.g., extent E1 remains in extent group EG1, extent E2 remains in extent group EG2), when vblocks “V, 1” or “V1, 1” are duplicated via snapshots, metadata entries 510, 512, and 514 remains denormalized.

Continuing from FIG. 5A, an extent is migrated from one extent group to another. For example, extent E1 is migrated from extent group EG1 to extent group EG5. Instead of updating each of metadata entries 510 and 512 to reflect the migration, a metadata entry in an extent id map 520 is generated. As shown in FIG. 5B, a metadata entry 522 in extent id map 520 is generated. If extent id map 520 does not already exist, one is generated, and a metadata entry 522 for extent E1 is generated along with extent id map 520. If an extent id map 520 already exists, metadata entry 522 for extent E1 is generated and added to extent id map 520. As shown, metadata entry 522 maps extent_id E1 to egroup_id EG5. However, instead of making any updates to metadata entries 510 and 512, metadata entries 510 and 512 are left unchanged and still refer to extent group EG1. Accordingly, when either metadata entries 510 or 512 are accessed to look up the extent group for extent E1, both metadata entries 510 and 512 still refer to extent group EG1. As a result, when an access is later made to extent E1 and the extent group EG1 is used to access extent group id map 504, the look up fails. In response to the failed lookup, the virtual disk manager then performs a lookup on extent id map 520 for extent E1 and then uses the metadata entry 522 to determine that extent group EG5 corresponds to extent E1. Metadata entry 522 for extent group EG5 is then read from extent group id map 504. In some embodiments, as a result of this access, the virtual disk manager additionally updates metadata entry 512 to add an egroup_mapping_in_eid_map flag set to true (not shown), so that further accesses can be handled without the extra lookup on extent group id map 504.

FIGS. 6A-6C illustrate an example of dynamic denormalization of metadata according to additional embodiments of the present disclosure. Over time, multiple snapshots of a vdisk are taken. These snapshots reflect changes to a vblock in the vdisk over time. For example, a vblock is overwritten one or more times, such that a number of vdisk snapshots that include data associated with an extent decreases. Further, certain snapshots are deleted entirely. FIG. 6A illustrates an example of metadata 500 from FIGS. 5A-5B further ahead in time. As shown, subsequent to the example illustrated in FIGS. 5A-2B, additional metadata 602, 604, and 606 for respective snapshots of the vdisk (V2, V7, and V8, respectively) had been generated. Further, metadata 506 and 602 for vdisk snapshots V and V2, respectively, had been deleted, as shown by metadata 506 and 602 being crossed out. Further, in metadata 606 for vdisk snapshot V8, vblock 1 had been overwritten such that vblock 1 in vdisk v8 no longer includes data associated with extent E1, as shown in metadata entry 608 by the reference to extent E7. As further shown, metadata 508 and 604 still refer to extent E1 in metadata entries 512 and 610, respectively, and correspondingly refer to metadata entry 522 for extent E1 with the no longer up-to-date egroup EG1, in extent id map 520. Metadata entry 522 continues to refer to EG5 metadata entry 524 in extent group id map 504.

When the number of vdisk snapshots that include data associated with an extent, and thereby has corresponding normalized metadata that includes a reference to the extent, is determined to meet a denormalization criterion, the metadata is dynamically denormalized. In some embodiments, a denormalization criterion is that the number of snapshots that include data associated with the extent meets or is below a threshold (e.g., 2 snapshots or versions of the vdisk as shown, however other numbers of snapshots can be used such as 3, 4, or more). In some embodiments, a denormalization criterion is a ratio or percentage of the number of snapshots that include data associated with the extent and a number of total snapshots meets or is below a threshold (e.g., 5% or 10%). More generally, the threshold is predefined or otherwise configured (e.g., by an administrator). Dynamic denormalization includes first updating the extent group references for that extent in the metadata. FIG. 6B illustrates the updating of extent group references. As descried above, metadata 508 and 604 still refer to extent E1 in metadata entries 512 and 610, respectively. In FIG. 6A, the associated metadata entries 512 and 610 include an outdated reference to extent group EG1 (e.g., the metadata includes egroup_id EG1). Using the mapping of extent_id to egroup_id included in entry 522, each of metadata entries 512 and 610 is updated to include a reference to extent group EG5 (e.g., to include egroup_id EG5), as shown in bold text in FIG. 6B. As shown in FIG. 6B, each of metadata entries 512 and 610 now refers to extent group EG5 metadata entry 524 in extent group id map 504. That is, metadata entries 512 and 610 are updated to include the mapping of extent_id E1 to egroup_id EG5.

Dynamic denormalization continues with deletion of an entry in extent id map 520. Continuing from FIG. 6B, after each of metadata entries 512 and 610 has been updated to include a reference to extent group EG5, metadata entry 522 in extent id map 520 is redundant and no longer needed. Accordingly, metadata entry 522 is deleted. In some embodiments, if metadata entry 522 is the last entry remaining in extent id map 520, then extent id map 520 is deleted in its entirety as well. As shown in FIG. 6C, with the updates to metadata entries 510 and 610 and deletion of metadata entry 522, metadata entries 510 and 610 refer directly to EG5 metadata entry 524 in extent group id map 504.

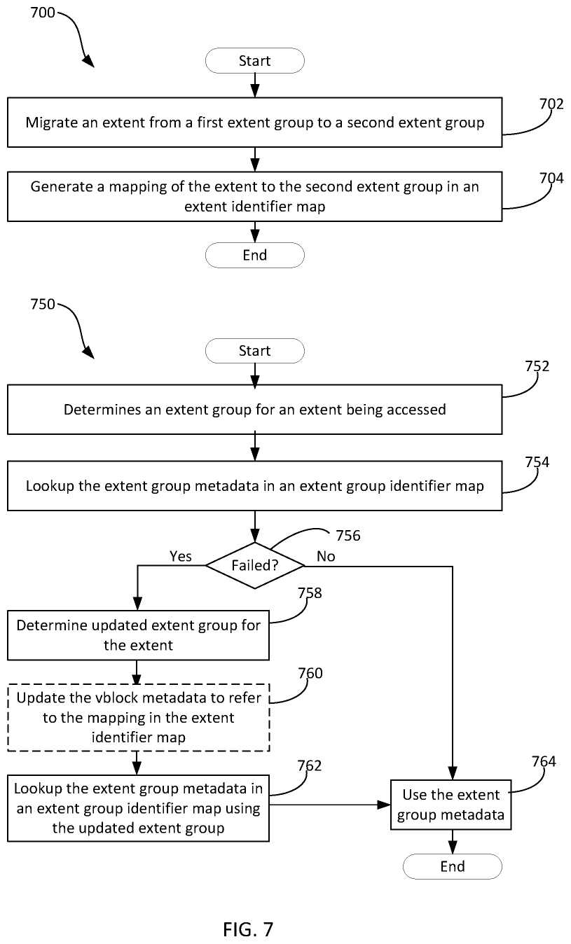

FIG. 7 is a flow diagram of method steps for dynamically normalizing metadata, according to additional embodiments of the present disclosure. In some embodiments, the method steps of FIG. 7 may be performed by any computing device or system implementing a virtual disk, such as any of the computing systems disclosed in FIGS. 9A-10 disclosed herein.

As shown in FIG. 7, a first method 700 begins at a step 702 where a virtual disk manager application migrates an extent from a first extent group to a second extent group. Migrating the extent includes associating the extent, which had been associated with the first extent group, with a second extent group. For example, referring to FIGS. 5A-5B, the virtual disk manager application migrates extent E1 from extent group EG1 to extent group EG5.

At step 704, in response to migrating the extent, the virtual disk manager application generates a mapping of the extent to the second extent group in an extent identifier map. For example, referring to FIGS. 5A and 5B, the virtual disk manager application, in response to the migration of extent E1, generates metadata entry 522 in extent id map 520 that maps extent E1 to extent group EG5.

As further shown in FIG. 7, a second method 750 begins at a step 752 where the virtual disk manager application determines an extent group for an extent being accessed. The access could be either a read access or a write access to the extent. The virtual disk manager looks up the extent in a vdisk block map. For example, referring to FIG. 5B, the virtual disk manager application reads metadata entry 512 from vdisk block map 502 to determine that extent group EG1 is the extent group for extent E1.

At a step 754, the virtual disk manager application uses the extent group determined during step 752 to lookup the extent group metadata in an extent group identifier map. For example, again referring to FIG. 5B, the virtual disk manager application attempt to lookup a metadata entry in extent group id map 504 corresponding to extent group EG1.

At step 756, the virtual disk manager application determines whether the lookup of step 754 was a success or failure. If the lookup was a failure (e.g., no extent group metadata for extent group EG1 was found in extent group id map 504), method 750 proceeds to step 758. If the lookup was successful, method 750 proceeds to step 764.

At step 758, the virtual disk manager application determines an updated extent group for the extent by looking up the extent in an extent id map. For example, again referring to FIG. 5B, the virtual disk manager application looks up extent E1 in extent id map 520 and determines from entry 522s that the updated extent group for extent E1 is extent group EG5.

At an optional step 760, the virtual disk manager application updates the vblock metadata to refer to the mapping in the extent identifier map. For example, the virtual disk manager application sets the egroup_mapping_in_eid_map in metadata entry 512 to true.

At step 762, the virtual disk manager application looks up to the extent group metadata in the extent group identifier map using the updated extent group. For example, again referring to FIG. 5B, the virtual disk manager application performs a lookup on extent group id map 504 using extent group EG5 to access the EG5 extent group metadata in metadata entry 522.

At step 764, the virtual disk manager application uses the extent group metadata to perform the access received during step 752.

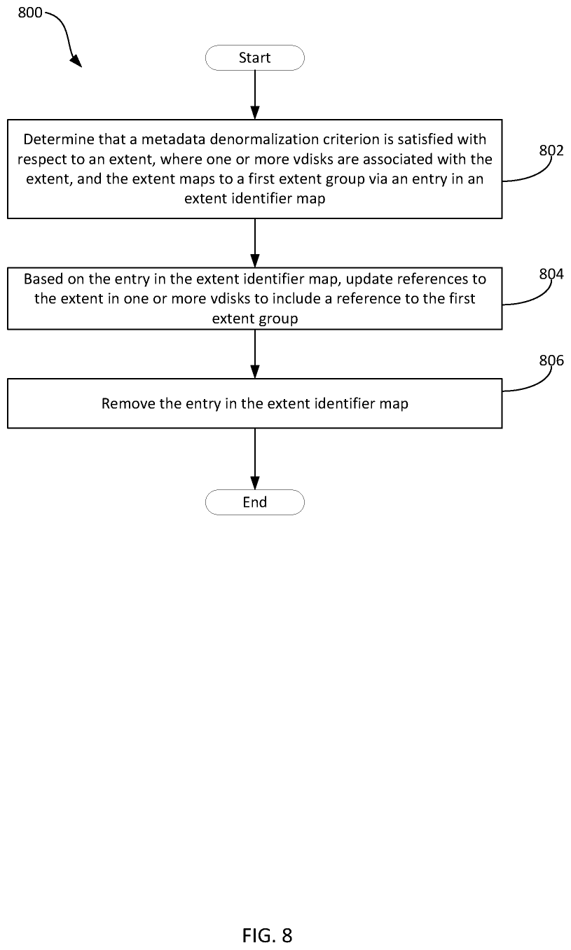

FIG. 8 is a flow diagram of method steps for dynamically denormalizing metadata, according to various embodiments of the present disclosure. In some embodiments, the method steps of FIG. 8 may be performed by any computing device or system implementing a virtual disk, such as any of the computing systems disclosed in FIGS. 9A-10 disclosed herein.

As shown in FIG. 8, a method 800 begins at a step 802, where a virtual disk manager application determines that a metadata denormalization criterion is satisfied with respect to an extent. One or more vdisks are associated with the extent, and the extent maps to a first extent group via an entry in an extent identifier map. A virtual disk manager application, performing a metadata curator capability, searches through metadata (e.g., metadata 200 or 500) to identify vblocks in vdisks (e.g., vblocks in versions/snapshots of the vdisk, versions/snapshots of the vblock) that are associated with the extent. For example, for metadata 200 as shown in FIG. 3A, the virtual disk manager application identifies metadata entries 212 and 310 or metadata entries 512 and 610 corresponding to respective vblocks that are associated with extent E1. Alternatively for metadata 500 as shown in FIG. 6A, the virtual disk manager application identifies metadata entries 512 and 610 corresponding to respective vblocks that are associated with extent E1. The virtual disk manager application determines that a number of those vblocks that are associated with extent E1 satisfies a metadata denormalization criterion. In some embodiments, one or more metadata denormalization criteria are directed to the number of vblocks that are associated with extent E1. In some embodiments, a criterion is that the number of vblocks throughout metadata 200 or alternatively metadata 500 that are associated with extent E1 has dropped to be at or below a threshold (e.g., dropped to 2 or fewer, 3 or fewer, 4 or fewer, etc.), and the corresponding metadata is not already denormalized. In some embodiments, a criterion is that the number of versions/snapshots of the vblock throughout metadata 200 or alternatively metadata 500 that are still associated with extent E1 is at a certain percentage or less of the total number of versions/snapshots of the vblock (e.g., 10% or less), and the corresponding metadata is not already denormalized. Additionally, in metadata 200 as shown in FIG. 3A, metadata entry 222 in extent id map 220 maps extent E1 to extent group EG5 and alternatively in metadata 500 as shown in FIG. 6A, metadata entry 522 in extent id map 520 maps extent E1 to extent group EG5.

At step 804, based on the entry in the extent identifier map, the virtual disk manager application updates reference(s) to the extent in the vdisks to include a reference to the first extent group. The virtual disk manager application updates the metadata of vblocks still associated with extent E1 to include a mapping to extent group EG5, based on the mapping in metadata entry 222. For example, in FIG. 3B, metadata entries 212 and 310 are both updated to include the egroup_id of extent group EG5. In some embodiments, the egroup_mapping_in_eid_map flags in metadata entries 210 and 212 is cleared. Alternatively, in FIG. 6B, metadata entries 512 and 610 are both updated to include the egroup_id of extent group EG5.

At step 806, the virtual disk manager application removes the entry in the extent identifier map. After the update performed in step 804, the virtual disk manager application removes (e.g., deletes) metadata entry 222 (or extent id map 220 entirely if metadata entry 222 is the only remaining entry) to free up memory space as shown in FIG. 3C. Alternatively the virtual disk manager application removes metadata entry 522 (or extent id map 520 entirely if metadata entry 522 is the only remaining entry) to free up memory space as shown in FIG. 6C. With the update in step 804 and the deletion of metadata entry 222, lookups for data corresponding to extent E1 would go from vdisk block map 202 directly to extent group id map 204. Alternatively, with the update in step 804 and the deletion of metadata entry 522, lookups for data corresponding to extent E1 would go from vdisk block map 502 directly to extent group id map 504.

At least one technical advantage of the disclosed techniques relative to the prior art is that, with the disclosed techniques, extent migrations and extent data lookups are more efficient compared to previous approaches. By normalizing metadata when an extent is migrated, a number of required updates to metadata duplicated across snapshots of vdisks is reduced, thereby reducing the expense in computing resources when migrating extents. By denormalizing metadata when a denormalization criterion is met, a level of metadata indirection is removed, thereby reducing a latency of looking up metadata to locate data associated with an extent. These technical advantages provide one or more technological advancements over prior art approaches.

### Exemplary Virtualization System Architectures

According to some embodiments, all or portions of any of the foregoing techniques described with respect to FIGS. 1-8 can be partitioned into one or more modules and instanced within, or as, or in conjunction with a virtualized controller in a virtual computing environment. Some example instances within various virtual computing environments are shown and discussed in further detail in FIGS. 9A-9D. Consistent with these embodiments, a virtualized controller includes a collection of software instructions that serve to abstract details of underlying hardware or software components from one or more higher-level processing entities. In some embodiments, a virtualized controller can be implemented as a virtual machine, as an executable container, or within a layer (e.g., such as a layer in a hypervisor). Consistent with these embodiments, distributed systems include collections of interconnected components that are designed for, or dedicated to, storage operations as well as being designed for, or dedicated to, computing and/or networking operations.

In some embodiments, interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

In some embodiments, a hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

In some embodiments, physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

FIG. 9A is a block diagram illustrating virtualization system architecture 10A00 configured to implement one or more aspects of the present embodiments. As shown in FIG. 9A, virtualization system architecture 10A00 includes a collection of interconnected components, including a controller virtual machine (CVM) instance 1030 in a configuration 1051. Configuration 1051 includes a computing platform 1006 that supports virtual machine instances that are deployed as user virtual machines, or controller virtual machines or both. Such virtual machines interface with a hypervisor (as shown). In some examples, virtual machines may include processing of storage I/O (input/output or IO) as received from any or every source within the computing platform. An example implementation of such a virtual machine that processes storage I/O is depicted as CVM instance 1030.

In this and other configurations, a CVM instance receives block I/O storage requests as network file system (NFS) requests in the form of NFS requests 1002, internet small computer storage interface (iSCSI) block IO requests in the form of iSCSI requests 1003, Samba file system (SMB) requests in the form of SMB requests 1004, and/or the like. The CVM instance publishes and responds to an internet protocol (IP) address (e.g., CVM IP address 1010). Various forms of input and output can be handled by one or more IO control handler functions (e.g., IOCTL handler functions 1008) that interface to other functions such as data IO manager functions 1014 and/or metadata manager functions 1022. As shown, the data IO manager functions can include communication with virtual disk configuration manager 1012 and/or can include direct or indirect communication with any of various block IO functions (e.g., NFS IO, iSCSI IO, SMB IO, etc.).

In addition to block IO functions, configuration 1051 supports IO of any form (e.g., block IO, streaming IO, packet-based IO, HTTP traffic, etc.) through either or both of a user interface (UI) handler such as UI IO handler 1040 and/or through any of a range of application programming interfaces (APIs), possibly through API IO manager 1045.

Communications link 1015 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), formatting of bit fields into fixed-length blocks or into variable length fields used to populate the payload, and/or the like. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

Computing platform 1006 include one or more computer readable media that is capable of providing instructions to a data processor for execution. In some examples, each of the computer readable media may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory (RAM). As shown, controller virtual machine instance 1030 includes content cache manager facility 1016 that accesses storage locations, possibly including local dynamic random access memory (DRAM) (e.g., through local memory device access block 1018) and/or possibly including accesses to local solid state storage (e.g., through local SSD device access block 1020).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 1031, which in turn can be formatted into any one or more storage areas, and which can comprise parameterized storage accessible by a key (e.g., a filename, a table name, a block address, an offset address, etc.). Data repository 1031 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 1024. The data repository 1031 can be configured using CVM virtual disk controller 1026, which can in turn manage any number or any configuration of virtual disks.

Execution of a sequence of instructions to practice certain of the disclosed embodiments is performed by one or more instances of a software instruction processor, or a processing element such as a data processor, or such as a central processing unit (e.g., CPU1, CPU2, . . . , CPUN). According to certain embodiments of the disclosure, two or more instances of configuration 1051 can be coupled by communications link 1015 (e.g., backplane, LAN, PSTN, wired or wireless network, etc.) and each instance may perform respective portions of sequences of instructions as may be required to practice embodiments of the disclosure.

The shown computing platform 1006 is interconnected to the Internet 1048 through one or more network interface ports (e.g., network interface port 1023₁ and network interface port 1023₂). Configuration 1051 can be addressed through one or more network interface ports using an IP address. Any operational element within computing platform 1006 can perform sending and receiving operations using any of a range of network protocols, possibly including network protocols that send and receive packets (e.g., network protocol packet 1021₁ and network protocol packet 1021₂).

Computing platform 1006 may transmit and receive messages that can be composed of configuration data and/or any other forms of data and/or instructions organized into a data structure (e.g., communications packets). In some cases, the data structure includes program instructions (e.g., application code) communicated through the Internet 1048 and/or through any one or more instances of communications link 1015. Received program instructions may be processed and/or executed by a CPU as it is received and/or program instructions may be stored in any volatile or non-volatile storage for later execution. Program instructions can be transmitted via an upload (e.g., an upload from an access device over the Internet 1048 to computing platform 1006). Further, program instructions and/or the results of executing program instructions can be delivered to a particular user via a download (e.g., a download from computing platform 1006 over the Internet 1048 to an access device).

Configuration 1051 is merely one example configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

In some embodiments, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to management of block stores. Various implementations of the data repository comprise storage media organized to hold a series of records and/or data structures.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 6B depicts a block diagram illustrating another virtualization system architecture configured to implement one or more aspects of the present embodiments. As shown in FIG. 6B, virtualization system architecture 10B00 includes a collection of interconnected components, including an executable container instance 1050 in a configuration 1052. Configuration 1052 includes a computing platform 1006 that supports an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In some embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 1050). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls” or “ls-a”, etc.). The executable container might optionally include operating system components 1078, however such a separate set of operating system components need not be provided. As an alternative, an executable container can include runnable instance 1058, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 1076. Such a container virtual disk controller can perform any of the functions that the aforementioned CVM virtual disk controller 1026 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 6C is a block diagram illustrating virtualization system architecture 10000 configured to implement one or more aspects of the present embodiments. As shown in FIG. 6C, virtualization system architecture 10000 includes a collection of interconnected components, including a user executable container instance in configuration 1053 that is further described as pertaining to user executable container instance 1070. Configuration 1053 includes a daemon layer (as shown) that performs certain functions of an operating system.

User executable container instance 1070 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 1058). In some cases, the shown operating system components 1078 comprise portions of an operating system, which portions are interfaced with or included in the runnable instance and/or any user containerized functions. In some embodiments of a daemon-assisted containerized architecture, computing platform 1006 might or might not host operating system components other than operating system components 1078. More specifically, the shown daemon might or might not host operating system components other than operating system components 1078 of user executable container instance 1070.

In some embodiments, the virtualization system architecture 10A00, 10B00, and/or 10000 can be used in any combination to implement a distributed platform that contains multiple servers and/or nodes that manage multiple tiers of storage where the tiers of storage might be formed using the shown data repository 1031 and/or any forms of network accessible storage. As such, the multiple tiers of storage may include storage that is accessible over communications link 1015. Such network accessible storage may include cloud storage or networked storage (e.g., a SAN or storage area network). Unlike prior approaches, the disclosed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In some embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

In some embodiments, any one or more of the aforementioned virtual disks can be structured from any one or more of the storage devices in the storage pool. In some embodiments, a virtual disk is a storage abstraction that is exposed by a controller virtual machine or container to be used by another virtual machine or container. In some embodiments, the virtual disk is exposed by operation of a storage protocol such as iSCSI or NFS or SMB. In some embodiments, a virtual disk is mountable. In some embodiments, a virtual disk is mounted as a virtual storage device.

In some embodiments, some or all of the servers or nodes run virtualization software. Such virtualization software might include a hypervisor (e.g., as shown in configuration 1051) to manage the interactions between the underlying hardware and user virtual machines or containers that run client software.

Distinct from user virtual machines or user executable containers, a special controller virtual machine (e.g., as depicted by controller virtual machine instance 1030) or as a special controller executable container is used to manage certain storage and I/O activities. Such a special controller virtual machine is sometimes referred to as a controller executable container, a service virtual machine (SVM), a service executable container, or a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 6D is a block diagram illustrating virtualization system architecture 10D00 configured to implement one or more aspects of the present embodiments. As shown in FIG. 6D, virtualization system architecture 10D00 includes a distributed virtualization system that includes multiple clusters (e.g., cluster 1083₁, . . . , cluster 1083_{N}) comprising multiple nodes that have multiple tiers of storage in a storage pool. Representative nodes (e.g., node 1081₁₁, . . . , node 1081_{1M}) and storage pool 1090 associated with cluster 1083₁ are shown. Each node can be associated with one server, multiple servers, or portions of a server. The nodes can be associated (e.g., logically and/or physically) with the clusters. As shown, the multiple tiers of storage include storage that is accessible through a network 1096, such as a networked storage 1086 (e.g., a storage area network or SAN, network attached storage or NAS, etc.). The multiple tiers of storage further include instances of local storage (e.g., local storage 1091₁₁, . . . , local storage 1091_{1M}). For example, the local storage can be within or directly attached to a server and/or appliance associated with the nodes. Such local storage can include solid state drives (SSD 1093₁₁, . . . , SSD 1093_{1M}), hard disk drives (HDD 1094₁₁, . . . , HDD 1094_{1M}), and/or other storage devices.

As shown, any of the nodes of the distributed virtualization system can implement one or more user virtualized entities (e.g., VE 1088₁₁₁, . . . , VE 1088_{11K}, . . . , VE 1088_{1M1}, . . . , VE 1088_{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 1087₁₁, . . . , host operating system 1087_{1M}), while the VMs run multiple applications on various respective guest operating systems. Such flexibility can be facilitated at least in part by a hypervisor (e.g., hypervisor 1085₁₁, . . . , hypervisor 1085_{1M}), which hypervisor is logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers are implemented at the nodes in an operating system virtualization environment or container virtualization environment. The executable containers can include groups of processes and/or resources (e.g., memory, CPU, disk, etc.) that are isolated from the node host computer and other containers. Such executable containers directly interface with the kernel of the host operating system (e.g., host operating system 1087₁₁, . . . , host operating system 1087_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 1090 by the VMs and/or the executable containers.

Multiple instances of such virtualized controllers can coordinate within a cluster to form the distributed storage system 1092 which can, among other operations, manage the storage pool 1090. This architecture further facilitates efficient scaling in multiple dimensions (e.g., in a dimension of computing power, in a dimension of storage space, in a dimension of network bandwidth, etc.).

In some embodiments, a particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 1081₁₁ can interface with a controller virtual machine (e.g., virtualized controller 1082₁₁) through hypervisor 1085₁₁ to access data of storage pool 1090. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 1092. For example, a hypervisor at one node in the distributed storage system 1092 might correspond to software from a first vendor, and a hypervisor at another node in the distributed storage system 1092 might correspond to a second software vendor. As another virtualized controller implementation example, executable containers can be used to implement a virtualized controller (e.g., virtualized controller 1082_{1M}) in an operating system virtualization environment at a given node. In this case, for example, the virtualized entities at node 1081_{1M} can access the storage pool 1090 by interfacing with a controller container (e.g., virtualized controller 1082_{1M}) through hypervisor 1085_{1M} and/or the kernel of host operating system 1087_{1M}.

In some embodiments, one or more instances of an agent can be implemented in the distributed storage system 1092 to facilitate the herein disclosed techniques. Specifically, agent 1084₁₁ can be implemented in the virtualized controller 1082₁₁, and agent 1084_{1M} can be implemented in the virtualized controller 1082_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

### Exemplary Computer System

FIG. 10 is a block diagram illustrating a computer system 1100 configured to implement one or more aspects of the present embodiments. In some embodiments, computer system 1100 may be representative of a computer system for implementing one or more aspects of the embodiments disclosed in FIGS. 1-10D. In some embodiments, computer system 1100 is a server machine operating in a data center or a cloud computing environment. suitable for implementing an embodiment of the present disclosure. As shown, computer system 1100 includes a bus 1102 or other communication mechanism for communicating information, which interconnects subsystems and devices, such as one or more processors 1104, memory 1106, storage 1108, optional display 1110, one or more input/output devices 1112, and a communications interface 1114. Computer system 1100 described herein is illustrative and any other technically feasible configurations fall within the scope of the present disclosure.

The one or more processors 1104 include any suitable processors implemented as a central processing unit (CPU), a graphics processing unit (GPU), an application-specific integrated circuit (ASIC), a field programmable gate array (FPGA), an artificial intelligence (AI) accelerator, any other type of processor, or a combination of different processors, such as a CPU configured to operate in conjunction with a GPU. In general, the one or more processors 1104 may be any technically feasible hardware unit capable of processing data and/or executing software applications. Further, in the context of this disclosure, the computing elements shown in computer system 1100 may correspond to a physical computing system (e.g., a system in a data center) or may be a virtual computing instance, such as any of the virtual machines described in FIGS. 9A-9D.

Memory 1106 includes a random access memory (RAM) module, a flash memory unit, and/or any other type of memory unit or combination thereof. The one or more processors 1104, and/or communications interface 1114 are configured to read data from and write data to memory 1106. Memory 1106 includes various software programs that include one or more instructions that can be executed by the one or more processors 1104 and application data associated with said software programs.

Storage 1108 includes non-volatile storage for applications and data, and may include one or more fixed or removable disk drives, HDDs, SSD, NVMes, vDisks, flash memory devices, and/or other magnetic, optical, and/or solid state storage devices.

Communications interface 1114 includes hardware and/or software for coupling computer system 1100 to one or more communication links 1116. The one or more communication links 1116 may include any technically feasible type of communications network that allows data to be exchanged between computer system 1100 and external entities or devices, such as a web server or another networked computing system. For example, the one or more communication links 1116 may include one or more wide area networks (WANs), one or more local area networks (LANs), one or more wireless (WiFi) networks, the Internet, and/or the like.

1. In some embodiments, one or more non-transitory computer-readable media store program instructions that, when executed by one or more processors, cause the one or more processors to perform steps of migrating an extent from a first extent group to a second extent group, wherein one or more vblocks are associated with the extent in a first metadata map; in response to migrating the extent: generating a first mapping of the extent to the second extent group in a second metadata map; identifying one or more vblocks associated with the extent in the first metadata map; and updating metadata associated with the identified one or more vblocks in the first metadata map to refer to the first mapping in the second metadata map.

2. The one or more non-transitory computer-readable media of clause 1, wherein an identifier of the extent is a key to the first mapping in the second metadata map.

3. The one or more non-transitory computer-readable media of clauses 1 or 2, wherein the first metadata map comprises, for a first vblock, an offset of a region associated with the extent in the first vblock and a length of the region.

4. The one or more non-transitory computer-readable media of any of clauses 1-3, wherein the first metadata map comprises, for a first vblock, an identifier of the extent and an identifier of the first extent group.

5. The one or more non-transitory computer-readable media of any of clauses 1-4, wherein the first mapping includes a flag indicating that the first mapping is stored in the second metadata map.

6. The one or more non-transitory computer-readable media of any of clauses 1-5, wherein the steps further comprise obtaining an identifier of the extent from the first metadata map; based on the identifier of the extent, obtaining an identifier of the second extent group from the first mapping; and based on the identifier of the second extent group, determining a location associated with the extent on a physical storage device.

7. In some embodiments, a method for normalizing virtual block (vblock) metadata comprises migrating an extent from a first extent group to a second extent group, wherein one or more vblocks are associated with the extent in a first metadata map; in response to migrating the extent: generating a first mapping of the extent to the second extent group in a second metadata map; identifying one or more vblocks associated with the extent in the first metadata map; and updating metadata associated with the identified one or more vblocks in the first metadata map to refer to the first mapping in the second metadata map.

8. The method of clause 7, wherein an identifier of the extent is a key to the first mapping in the second metadata map.

9. The method of clauses 7 or 8, wherein the first metadata map comprises, for a first vblock, an offset of a region associated with the extent in the first vblock and a length of the region.

10. The method of any of clauses 7-9, wherein the first metadata map comprises, for a first vblock, an identifier of the extent and an identifier of the first extent group.

11. The method of any of clauses 7-10, wherein the first mapping includes a flag indicating that the first mapping is stored in the second metadata map.

12. The method of any of clauses 7-11, further comprising obtaining an identifier of the extent from the first metadata map; based on the identifier of the extent, obtaining an identifier of the second extent group from the first mapping; and based on the identifier of the second extent group, determining a location associated with the extent on a physical storage device.

13. In some embodiments, a system comprises a memory storing a set of instructions; and one or more processors that, when executing the set of instructions, are configured to migrate an extent from a first extent group to a second extent group, wherein one or more vblocks are associated with the extent in a first metadata map; in response to migrating the extent: generate a first mapping of the extent to the second extent group in a second metadata map; identify one or more vblocks associated with the extent in the first metadata map; and update metadata associated with the identified one or more vblocks in the first metadata map to refer to the first mapping in the second metadata map.

14. The system of clause 13, wherein an identifier of the extent is a key to the first mapping in the second metadata map.

15. The system of clauses 13 or 14, wherein the first metadata map comprises, for a first vblock, an offset of a region associated with the extent in the first vblock and a length of the region.

16. The system of any of clauses 13-15, wherein the first metadata map comprises, for a first vblock, an identifier of the extent and an identifier of the first extent group.

17. The system of any of clauses 13-16, wherein the first mapping includes flag indicating that the first mapping is stored in the second metadata map.

18. The system of any of clauses 13-17, wherein the one or more processors, when executing the set of instructions, are further configured to obtain an identifier of the extent from the first metadata map; based on the identifier of the extent, obtain an identifier of the second extent group from the first mapping; and based on the identifier of the second extent group, determine a location associated with the extent on a physical storage device.

19. In some embodiments, one or more non-transitory computer-readable media store program instructions that, when executed by one or more processors, cause the one or more processors to perform steps of identifying a plurality of vblocks that are associated with an extent in a plurality of virtual disks (vdisks); in response to determining that a number of the identified plurality of vblocks associated with the extent satisfies a denormalization criterion: updating metadata associated with the identified plurality of vblocks in a first metadata map to include an identifier of a first extent group included in a first mapping of a second metadata map, the first mapping associating the extent with the first extent group; and removing the first mapping from the second metadata map.

20. The one or more non-transitory computer-readable media of clause 19, wherein updating the metadata associated with the identified plurality of vblocks in the first metadata map further comprises resetting a flag indicating that the identifier of the first extent group is stored in the second metadata map.

21. The one or more non-transitory computer-readable media of clauses 19 or 20, wherein the metadata associated with the first vblock comprises an offset of a region associated with the extent in the first vblock and a length of the region.

22. The one or more non-transitory computer-readable media of any of clauses 19-21, wherein the metadata associated with the first vblock comprises an identifier of the extent.

23. The one or more non-transitory computer-readable media of any of clauses 19-22, further comprising looking up data corresponding to the extent by obtaining an identifier of the first extent group from the first metadata map; and based on the identifier of the first extent group, determining a location associated with the extent on a physical storage device.

24. In some embodiments, a method for denormalizing virtual block (vblock) metadata comprises identifying a plurality of vblocks that are associated with an extent in a plurality of virtual disks (vdisks); in response to determining that a number of the identified plurality of vblocks associated with the extent satisfies a denormalization criterion: updating metadata associated with the identified plurality of vblocks in a first metadata map to include an identifier of a first extent group included in a first mapping of a second metadata map, the first mapping associating the extent with the first extent group; and removing the first mapping from the second metadata map.

25. The method of clause 24, wherein updating the metadata associated with the identified plurality of vblocks in the first metadata map further comprises resetting a flag indicating that the identifier of the first extent group is stored in the second metadata map.

26. The method of clauses 24 or 25, wherein the metadata associated with the first vblock comprises an offset of a region associated with the extent in the first vblock and a length of the region.

27. The method of any of clauses 24-26, wherein the metadata associated with the first vblock comprises an identifier of the extent.

28. The method of any of clauses 24-27, further comprising obtaining an identifier of the first extent group from the first metadata map; and based on the identifier of the first extent group, determining a location associated with the extent on a physical storage device.

29. In some embodiments, a system comprises a memory storing a set of instructions; and one or more processors that, when executing the set of instructions, are configured to identify a plurality of vblocks that are associated with an extent in a plurality of virtual disks (vdisks); in response to determining that a number of the identified plurality of vblocks associated with the extent satisfies a denormalization criterion: update metadata associated with the identified plurality of vblocks in a first metadata map to include an identifier of a first extent group included in a first mapping of a second metadata map, the first mapping associating the extent with the first extent group; and remove the first mapping from the second metadata map.

30. The system of clause 29, wherein the one or more processors, when executing the set of instructions, are further configured to reset a flag indicating that the identifier of the first extent group is stored in the second metadata map.

31. The system of clauses 29 or 30, wherein the metadata associated with the first vblock comprises an offset of a region associated with the extent in the first vblock and a length of the region.

32. The system of any of clauses 29-31, wherein the metadata associated with the first vblock comprises an identifier of the extent.

33. The system of any of clauses 29-32, wherein the one or more processors, when executing the set of instructions, are further configured to obtain an identifier of the first extent group from the first metadata map; and based on the identifier of the first extent group, determine a location associated with the extent on a physical storage device.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. One or more non-transitory computer-readable media storing program instructions that, when executed by one or more processors, cause the one or more processors to perform steps of:
migrating an extent from a first extent group to a second extent group, wherein one or more vblocks are associated with the extent in a first metadata map;
in response to migrating the extent:
adding a first mapping of the extent to the second extent group in a second metadata map;
identifying one or more vblocks associated with the extent in the first metadata map; and
updating metadata associated with the identified one or more vblocks in the first metadata map to refer to the first mapping in the second metadata map.

2. The one or more non-transitory computer-readable media of claim 1, wherein an identifier of the extent is a key to the first mapping in the second metadata map.

3. The one or more non-transitory computer-readable media of claim 1, wherein the first metadata map comprises, for a first vblock, an offset of a region associated with the extent in the first vblock and a length of the region.

4. The one or more non-transitory computer-readable media of claim 1, wherein the first metadata map comprises, for a first vblock, an identifier of the extent and an identifier of the first extent group.

5. The one or more non-transitory computer-readable media of claim 1, wherein the first mapping includes a flag indicating that the first mapping is stored in the second metadata map.

6. The one or more non-transitory computer-readable media of claim 1, wherein the steps further comprise:
obtaining an identifier of the extent from the first metadata map;
based on the identifier of the extent, obtaining an identifier of the second extent group from the first mapping; and
based on the identifier of the second extent group, determining a location associated with the extent on a physical storage device.

7. The one or more non-transitory computer-readable media of claim 1, wherein the identifying of the one or more vblocks associated with the extent in the first metadata map and the updating of the metadata associated with the identified one or more vblocks occurs in response to an access request received for the extent after adding the first mapping of the extent to the second extent group in the second metadata map.

8. A method for normalizing virtual block (vblock) metadata, comprising:
migrating an extent from a first extent group to a second extent group, wherein one or more vblocks are associated with the extent in a first metadata map;
in response to migrating the extent:
adding a first mapping of the extent to the second extent group in a second metadata map;
identifying one or more vblocks associated with the extent in the first metadata map; and
updating metadata associated with the identified one or more vblocks in the first metadata map to refer to the first mapping in the second metadata map.

9. The method of claim 8, wherein an identifier of the extent is a key to the first mapping in the second metadata map.

10. The method of claim 8, wherein the first metadata map comprises, for a first vblock, an offset of a region associated with the extent in the first vblock and a length of the region.

11. The method of claim 8, wherein the first metadata map comprises, for a first vblock, an identifier of the extent and an identifier of the first extent group.

12. The method of claim 8, wherein the first mapping includes a flag indicating that the first mapping is stored in the second metadata map.

13. The method of claim 8, further comprising:
obtaining an identifier of the extent from the first metadata map;
based on the identifier of the extent, obtaining an identifier of the second extent group from the first mapping; and
based on the identifier of the second extent group, determining a location associated with the extent on a physical storage device.

14. The method of claim 8, wherein the identifying of the one or more vblocks associated with the extent in the first metadata map and the updating of the metadata associated with the identified one or more vblocks occurs in response to an access request received for the extent after adding the first mapping of the extent to the second extent group in the second metadata map.

15. A system comprising:
a memory storing a set of instructions; and
one or more processors that, when executing the set of instructions, are configured to:
migrate an extent from a first extent group to a second extent group, wherein one or more vblocks are associated with the extent in a first metadata map;
in response to migrating the extent:
add a first mapping of the extent to the second extent group in a second metadata map;
identify one or more vblocks associated with the extent in the first metadata map; and
update metadata associated with the identified one or more vblocks in the first metadata map to refer to the first mapping in the second metadata map.

16. The system of claim 15, wherein an identifier of the extent is a key to the first mapping in the second metadata map.

17. The system of claim 15, wherein the first metadata map comprises, for a first vblock, an offset of a region associated with the extent in the first vblock and a length of the region.

18. The system of claim 15, wherein the first metadata map comprises, for a first vblock, an identifier of the extent and an identifier of the first extent group.

19. The system of claim 15, wherein the first mapping includes flag indicating that the first mapping is stored in the second metadata map.

20. The system of claim 15, wherein the one or more processors, when executing the set of instructions, are further configured to:
obtain an identifier of the extent from the first metadata map;
based on the identifier of the extent, obtain an identifier of the second extent group from the first mapping; and
based on the identifier of the second extent group, determine a location associated with the extent on a physical storage device.

21. The system of claim 15, wherein the identifying of the one or more vblocks associated with the extent in the first metadata map and the updating of the metadata associated with the identified one or more vblocks occurs in response to an access request received for the extent after adding the first mapping of the extent to the second extent group in the second metadata map.

22. One or more non-transitory computer-readable media storing program instructions that, when executed by one or more processors, cause the one or more processors to perform steps of:
identifying a plurality of vblocks that are associated with an extent in a plurality of virtual disks (vdisks);
in response to determining that a number of the identified plurality of vblocks associated with the extent satisfies a denormalization criterion:
updating metadata associated with the identified plurality of vblocks in a first metadata map to include an identifier of a first extent group included in a first mapping of a second metadata map, the first mapping associating the extent with the first extent group; and
removing the first mapping from the second metadata map.

23. The one or more non-transitory computer-readable media of claim 22, wherein updating the metadata associated with the identified plurality of vblocks in the first metadata map further comprises resetting a flag indicating that the identifier of the first extent group is stored in the second metadata map.

24. The one or more non-transitory computer-readable media of claim 22, wherein the metadata associated with a first vblock comprises an offset of a region associated with the extent in the first vblock and a length of the region.

25. The one or more non-transitory computer-readable media of claim 22, wherein the metadata associated with a first vblock comprises an identifier of the extent.

26. A method for denormalizing virtual block (vblock) metadata, comprising:
identifying a plurality of vblocks that are associated with an extent in a plurality of virtual disks (vdisks);
in response to determining that a number of the identified plurality of vblocks associated with the extent satisfies a denormalization criterion:
updating metadata associated with the identified plurality of vblocks in a first metadata map to include an identifier of a first extent group included in a first mapping of a second metadata map, the first mapping associating the extent with the first extent group; and
removing the first mapping from the second metadata map.

27. The method of claim 26, wherein updating the metadata associated with the identified plurality of vblocks in the first metadata map further comprises resetting a flag indicating that the identifier of the first extent group is stored in the second metadata map.

28. The method of claim 26, wherein the metadata associated with a first vblock comprises an offset of a region associated with the extent in the first vblock and a length of the region.

29. The method of claim 26, wherein the metadata associated with a first vblock comprises an identifier of the extent.

30. A system, comprising:
a memory storing a set of instructions; and
one or more processors that, when executing the set of instructions, are configured to:
identify a plurality of vblocks that are associated with an extent in a plurality of virtual disks (vdisks);
in response to determining that a number of the identified plurality of vblocks associated with the extent satisfies a denormalization criterion:
update metadata associated with the identified plurality of vblocks in a first metadata map to include an identifier of a first extent group included in a first mapping of a second metadata map, the first mapping associating the extent with the first extent group; and
remove the first mapping from the second metadata map.

31. The system of claim 30, wherein the one or more processors, when executing the set of instructions, are further configured to reset a flag indicating that the identifier of the first extent group is stored in the second metadata map.

32. The system of claim 30, wherein the metadata associated with a first vblock comprises an offset of a region associated with the extent in the first vblock and a length of the region.

33. The system of claim 30, wherein the metadata associated with a first vblock comprises an identifier of the extent.
